(19) United States
(12) Patent Application Publication
(10) Pub. No.: US 2025/0059349 A1
(43) Pub. Date: Feb. 20, 2025

(54) ELASTOMER COMPOSITION BASED ON AT LEAST ONE NITRILE OXIDE COMPOUND COMPRISING AN EPOXY GROUP

(71) Applicant: COMPAGNIE GENERALE DES ETABLISSEMENTS MICHELIN, Clermont-Ferrand (FR)

(72) Inventors: FRANCOIS JEAN-BAPTISTE-DIT-DOMINIQUE, Clermont-Ferrand (FR); KAHINA MAMMERI, Clermont-Ferrand (FR)

(21) Appl. No.: 18/722,812

(22) PCT Filed: Dec. 19, 2022
(86) PCT No.: PCT/EP2022/086554

§ 371 Date: Jun. 21, 2024

(30) Foreign Application Priority Data
Dec. 23, 2021 (FR) 2114420

(51) Int. Cl. C08K 5/32; B60C 1/00; C08J 3/24; C08K 3/04; C08K 3/36

(52) U.S. Cl. CPC C08K 5/32; B60C 1/0016; C08J 3/245; C08K 3/04; C08K 3/36; C08J 2307/00

(57) ABSTRACT

The invention relates to an elastomeric composition based on at least one diene elastomer, at least one reinforcing filler, at least one crosslinking agent and at least one compound, optionally already grafted onto said diene elastomer, of the following formula (I):

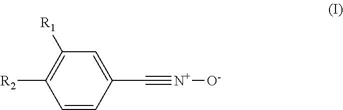

in which:
   R₁ represents a chemical group selected from the group consisting of —OCH₃, —OCH₂CH₃ and —OR₃;
   R₂ represents a chemical group selected from the group consisting of —OCH₃ and —OR₃;
   provided that R₁ or R₂ is —OR₃;
   R₃ represents a chemical group of formula (II)

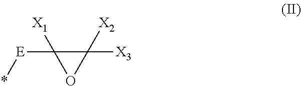

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol*represents the attachment of the group of formula (II) to the oxygen atom.

The invention also relates to a semi-finished article for a tyre and to a tyre comprising such a composition or such a semi-finished article.

The present invention relates to an elastomeric composition, in particular usable for the manufacture of tyres, based on at least one diene elastomer, on at least one reinforcing filler, on at least one crosslinking agent and on at least one aromatic nitrile oxide compound bearing an epoxy ring in the para or meta position relative to the nitrile oxide function and not possessing a substituent in the position ortho to this nitrile oxide function. The application also relates to a process for preparing such a composition and also to a semi-finished article for a tyre and to a tyre comprising such an elastomeric composition.

In the industrial field, mixtures of polymers with fillers are often used. In order for such mixtures to have good properties, means for improving the dispersion of the fillers within the polymers are continually being sought.

In particular, for elastomeric compositions intended for tyre manufacture, manufacturers are constantly in search of filled elastomeric compositions which have good mechanical properties, such as reinforcement, and a hysteresis that is as low as possible. Specifically, reduction of the hysteresis of an elastomeric composition is favourable for reducing the rolling resistance of a tyre and thus reducing the fuel consumption of a vehicle driving with such tyres.

It is known that, generally, in order to obtain the optimum reinforcing properties conferred by a reinforcing filler, it is advisable for the latter to be present in the elastomeric matrix in a final form which is both as finely divided as possible and as homogeneously distributed as possible. Many solutions have already been tried for achieving good dispersion of the reinforcing filler in an elastomeric composition and for obtaining elastomeric compositions having good reinforcing properties.

Mention may in particular be made of the use, in an elastomeric composition, of polymers having a structure which has been modified by means of functionalization agents, coupling agents or star-branching agents with the aim of obtaining a good interaction between the polymer thus modified and the reinforcing filler, whether this be carbon black or a reinforcing inorganic filler.

For example, the document WO2019102132A1 discloses an elastomeric composition comprising a styrene/butadiene copolymer onto which has been grafted a functionalization agent, either 2-(glycidyloxy)-1-naphthonitrile oxide or 2,4,6-trimethyl-3-(oxiran-2-ylmethoxy)benzonitrile oxide. The copolymers thus grafted make it possible to obtain elastomeric compositions having an improved reinforcement index compared to an elastomeric composition comprising an ungrafted styrene/butadiene copolymer. The improvement in the reinforcement of these compositions is obtained while maintaining the hysteresis properties at a level identical to that of a composition comprising the ungrafted styrene/butadiene copolymer.

Since fuel savings and the need to protect the environment have become a priority, it has proved necessary to produce tyres having a rolling resistance which is as low as possible, that is to say comprising elastomeric compositions having a hysteresis that is as low as possible.

Obtaining an elastomeric composition with a hysteresis that is as low as possible, while at the same time maintaining a good performance level for the other properties, such as reinforcement and stiffness, is an ongoing challenge for tyre manufacturers. Indeed, it is known that a decrease in the hysteresis of elastomeric compositions is accompanied by a decrease in the cured stiffness. However, a tread must be stiff enough to ensure a good level of road behaviour of the tyre.

There is therefore an ongoing need to have available elastomeric compositions having hysteresis properties that are further improved compared to the prior art elastomeric compositions, without this improvement being obtained at the expense of the stiffness properties.

One aim of the present invention is therefore that of proposing novel elastomeric compositions possessing an improvement in the rolling resistance/stiffness compromise.

Pursuing its research, the Applicant has discovered, surprisingly, that an elastomeric composition based on at least one diene elastomer, on a reinforcing filler, on a crosslinking system and on a specific compound, an aromatic nitrile oxide bearing an epoxy ring in the para or meta position relative to the nitrile oxide function and not possessing a substituent in the position ortho to this nitrile oxide function, exhibits an improvement in the rolling resistance/stiffness compromise. Advantageously, these novel elastomeric compositions also exhibit improved reinforcement properties.

Thus, a first subject of the present invention therefore relates to an elastomeric composition based on at least one diene elastomer, at least one reinforcing filler, at least one crosslinking agent and at least one compound, optionally already grafted onto said diene elastomer, of the following formula (I):

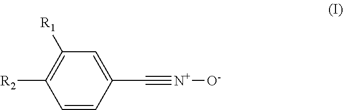

in which:
R₁ represents a chemical group selected from the group consisting of —OCH₃, —OCH₂CH₃ and —OR₃;
R₂ represents a chemical group selected from the group consisting of —OCH₃ and —OR₃;
provided that R₁ or R₂ is —OR₃;
R₃ represents a chemical group of formula (II)

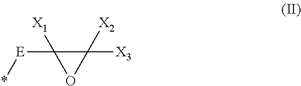

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol*represents the attachment of the group of formula (II) to the oxygen atom.

Preferentially, the content of compound of formula (I) is within a range extending from 0.05 mol % to 15 mol %, preferably from 0.05 mol % to 10 mol %, more preferentially from 0.07 to 5 mol %.

Preferentially, R₁ represents a chemical group selected from the group consisting of —OCH₃ and —OCH₂CH₃; and R₂ is —OR₃.

Preferentially, E represents a C1-C12 alkanediyl, preferably a C1-C10 alkanediyl, more preferentially a C1-C9 alkanediyl.

Preferentially, E is selected from the group consisting of methanediyl, ethanediyl and propanediyl.

Preferentially, the groups X₁, X₂, X₃, which may be identical or different, are selected from the group consisting of a hydrogen atom, C1-C6 alkyls and phenyl.

Preferentially, the groups X₁, X₂, X₃, which are identical, are a hydrogen atom.

Preferentially, the compound of formula (I) is the compound of formula (Ia1):

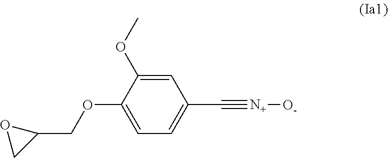

Preferentially, the diene elastomer is selected from the group consisting of ethylene/propylene/diene monomer copolymers, butyl rubbers, natural rubber, synthetic polyisoprenes, polybutadienes, butadiene copolymers, isoprene copolymers, and mixtures of these elastomers.

Preferentially, the diene elastomer is selected from the group consisting of natural rubber, synthetic polyisoprenes, polybutadienes, butadiene copolymers, isoprene copolymers and mixtures of these elastomers.

Preferentially, the diene elastomer is selected from the group consisting of natural rubber, synthetic polyisoprenes, polybutadienes, butadiene/styrene copolymers, ethylene/butadiene copolymers, isoprene/butadiene copolymers, isoprene/butadiene/styrene copolymers, isobutene/isoprene copolymers, isoprene/styrene copolymers, and mixtures of these elastomers. More preferentially, the diene elastomer is selected from the group consisting of natural rubber, synthetic polyisoprenes, polybutadienes, butadiene/styrene copolymers, ethylene/butadiene copolymers and mixtures of these elastomers.

Preferentially, the reinforcing filler is selected from carbon black, an inorganic reinforcing filler and mixtures thereof; more preferentially, the reinforcing filler predominantly comprises at least one silica.

Preferentially, the crosslinking system is a vulcanization system.

Another subject of the present invention relates to a semi-finished article for a tyre comprising at least one elastomeric composition defined above.

Preferentially, this semi-finished article for a tyre is a tyre tread.

Another subject of the invention relates to a tyre comprising at least one elastomeric composition defined above or at least one semi-finished article for a tyre above.

The invention and its advantages will be easily understood in the light of the description and exemplary embodiments which follow.

In the present text, unless expressly indicated otherwise, all the percentages (%) indicated are mass percentages (%).

Moreover, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The compounds mentioned in the description may be of fossil origin or biobased. In the latter case, they may be partially or completely derived from biomass or obtained from renewable starting materials derived from biomass. Of course, the compounds mentioned may also originate from the recycling of already-used materials, that is to say that they may partially or completely result from a recycling process, or else be obtained from starting materials which themselves result from a recycling process. This notably relates to polymers, plasticizers, fillers, etc.

The expression “composition based on” should be understood to mean a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

The expression “part by weight per hundred parts by weight of elastomer” (or phr) should be understood as meaning, for the purposes of the present invention, the part by mass per hundred parts by mass of elastomer.

When reference is made to a “predominant” compound, this is understood to mean, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. In the same way, a “predominant” filler is that representing the greatest mass among the fillers of the composition. By way of example, in a system comprising just one elastomer, the latter is predominant within the meaning of the present invention; and in a system comprising two elastomers, the predominant elastomer represents more than half of the mass of the elastomers, preferably more than 51% by mass of the total mass of the elastomers.

The term “1,3-dipolar compound” is understood according to the definition given by the IUPAC. By definition, a 1,3-dipolar compound comprises a dipole.

For the purposes of the present invention, the term “hydrocarbon chain” means a chain comprising one or more carbon atoms and one or more hydrogen atoms.

The expression “Ci-Cj alkyl” denotes a linear, branched or cyclic hydrocarbon group comprising from i to j carbon atoms; i and j being integers.

The expression “Ci-Cj aryl” denotes an aromatic group comprising from i to j carbon atoms; i and j being integers.

The term “Ci-Cj alkanediyl” is understood to mean a hydrocarbon group derived from a Ci-Cj alkane as defined above and in which two hydrogen atoms have been removed. An alkanediyl is therefore a divalent group.

The term “modified elastomer obtained by grafting” or “elastomer modified by grafting” refers to an elastomer comprising functions, in particular epoxy rings, which have been introduced into the elastomer chain. In practice, the modified elastomer is obtained by a grafting reaction of a compound bearing functions which are epoxy rings and bearing a function that is capable of forming a covalent bond with an unsaturation of the elastomer, this function capable of forming a covalent bond being a nitrile oxide. The grafting reaction is thus the attachment via a covalent bond of the compound of formula (I) bearing epoxy rings to at least one unsaturation of the elastomer chain.

As is known, an elastomer generally comprises at least one main elastomer chain. This elastomer chain may be termed the main chain as long as all the other chains of the elastomer are considered to be pendent chains, as mentioned in the document “Glossary of basic terms in polymer science” (IUPAC recommendations 1996), PAC, 1996, 68, 2287, page 2294.

The term “unsaturation” is understood to mean a multiple covalent bond between two carbon atoms: this multiple covalent bond may be a carbon-carbon double bond or a carbon-carbon triple bond, preferably a carbon-carbon double bond.

For the purposes of the present invention, the term “initial elastomer chain” is understood to mean the elastomer chain before the grafting reaction, this chain comprising at least one unsaturation that is capable of reacting with the compound of formula (I) described above. The initial elastomer is thus the elastomer serving as the starting reactant during the grafting reaction. The grafting reaction makes it possible, starting from an initial elastomer, to obtain a modified elastomer.

In the remainder of the text, the term “content of compounds of formula (I)”, including preferred forms thereof, present in an elastomeric composition, expressed as molar percentage, is understood to mean the number of moles of compounds of formula (I) present in the composition per hundred moles of constituent unit constituting the diene elastomer of the composition, regardless of whether these be diene or non-diene units. For example, if the content of compounds of formula (I), or of preferred forms thereof, relative to an SBR (styrene/butadiene rubber) is 0.20 mol %, this means that there will be 0.20 units derived from compound of formula (I) (or preferred forms) per 100 constituent units of SBR. The molar content of compounds of formula (I) can be determined by conventional polymer analysis methods, such as for example ¹H NMR analysis. In the case in which both an elastomer already grafted by the compound of formula (I) (or preferred forms thereof) and a diene elastomer not grafted by the compound of formula (I) are used in the composition, the content of compound of formula (I) (or preferred forms thereof) represents the number of compounds of formula (I) grafted per 100 units of diene elastomers, the number of units taking into account both elastomers (grafted and ungrafted), it being assumed that other compounds of formula (I) not already grafted have not been added to the composition.

The invention and its advantages will be easily understood in the light of the description and exemplary embodiments which follow.

### Compound of Formula (I)

The composition comprises at least one compound, optionally already grafted onto said diene elastomer, of the following formula (I):

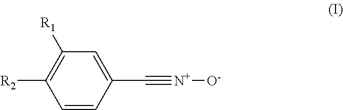

in which:
   R₁ represents a chemical group selected from the group consisting of —OCH₃, —OCH₂CH₃ and —OR₃;
   R₂ represents a chemical group selected from the group consisting of —OCH₃ and —OR₃;
   provided that R₁ or R₂ is —OR₃;
   R₃ represents a chemical group of formula (II)

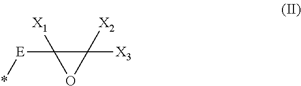

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol*represents the attachment of the group of formula (II) to the oxygen atom.

More advantageously, among the compounds of formula (I), the compounds more particularly preferred are those of formula (Ia):

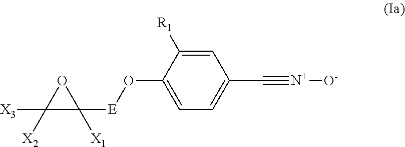

in which:
   R₁ represents a chemical group selected from the group consisting of —OCH₃ and —OCH₂CH₃; more preferentially R₁ represents —OCH₃,
   E represents a divalent C1-C12 hydrocarbon group optionally comprising one or more heteroatoms; and
   X₁, X₂, X₃, which may be identical or different, represent a hydrogen atom, a C1-C6 alkyl or a C6-C14 aryl.

Thus, a group of compounds of formula (I) that are particularly preferred are those for which R₁ represents a chemical group selected from the group consisting of —OCH₃ and —OCH₂CH₃ and R₂ is —OR₃. In other words, this group of compounds is that corresponding to the set formed by the compounds of preferred formula (Ia).

Preferentially, in the compounds of formula (I), the provision “R₁ or R₂ is —OR₃” means that if R₁ is —OCH₃ or —OCH₂CH₃ then R² is —OR₃; or if R₁ is —OR₃ then R₂ is —OCH₃. There is necessarily one (1) (and only 1)—OR₃ group in these compounds, either as substituent R₁ or as substituent R₂.

In the compounds of formulae (I) and (Ia), E represents a divalent C1-C12 hydrocarbon group that may optionally contain one or more heteroatoms. For the purposes of the present invention, the term “divalent hydrocarbon group” is understood to mean a spacer group (or linking group) forming a bridge between the oxygen atom attached to the aromatic ring and the epoxy ring bearing groups X₁, X₂, X₃; this spacer group E comprising from 1 to 12 carbon atoms and optionally being able to contain one or more heteroatoms such as for example N, O and S. This spacer group may be a, preferably saturated, linear or branched C1-C12 hydrocarbon chain which may optionally contain one or more heteroatoms such as for example N, O and S. Said hydrocarbon chain may optionally be substituted, provided that the substituents do not react with the nitrile oxide function and the epoxy ring as defined above.

Preferentially, in the compounds of formulae (I) and (Ia), E represents a divalent C1-C10, preferably C1-C9, hydrocarbon group that may optionally contain one or more heteroatoms such as for example N, O and S.

More preferentially, in the compounds of formulae (I) and (Ia), E represents a C1-C12 alkanediyl, preferably a C1-C10 alkanediyl, more preferentially a C1-C9 alkanediyl. More preferentially still, E is selected from the group consisting of methanediyl, ethanediyl and propanediyl.

Preferentially, in the compounds of formulae (I) and (Ia), X₁, X₂, X₃, which may be identical or different, are selected from the group consisting of a hydrogen atom, C1-C6 alkyls and C6-C14 aryls.

Preferentially, in the compounds of formulae (I) and (Ia), X₁, X₂, X₃, which may be identical or different, are selected from the group consisting of a hydrogen atom, C1-C6 alkyls and phenyl.

Preferentially, in the compounds of formulae (I) and (Ia), X₁, X₂, X₃, which may be identical or different, are selected from the group consisting of a hydrogen atom, C1-C3 alkyls and phenyl.

According to a preferred embodiment of the invention, in the compounds of formulae (I) and (Ia), X₁, X₂, X₃, which are identical, represent a hydrogen atom.

According to another preferred embodiment of the invention, in the compounds of formulae (I) and (Ia), X₁ and X₂ represent a hydrogen atom and X₃ represents a phenyl.

According to another embodiment of the invention, in the compounds of formulae (I) and (Ia), X₃ is a hydrogen atom, and X₁ and X₂, which may be identical or different, represent a hydrogen atom or a methyl.

As indicated above, among the compounds of formula (I), particular preference is given to the compounds of formula (Ia)

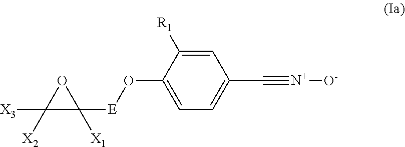

in which:
   R₁ represents a chemical group selected from the group consisting of —OCH₃ and —OCH₂CH₃; more preferentially R₁ represents-OCH₃;
   E represents a divalent C1-C12 hydrocarbon group optionally comprising one or more heteroatoms; and
   X₁, X₂, X₃, which may be identical or different, represent a hydrogen atom, a C1-C6 alkyl or a C6-C14 aryl.

Among the compounds (Ia), particular preference is given to those for which R₁ represents a chemical group selected from the group consisting of —OCH₃ and —OCH₂CH₃, E represents a C1-C12 alkanediyl, preferably a C1-C10 alkanediyl, more preferentially a C1-C9 alkanediyl and X₁, X₂, X₃, which may be identical or different, are selected from the group consisting of a hydrogen atom, C1-C3 alkyls and phenyl, more preferentially X₁, X₂, X₃, which are identical, are a hydrogen atom.

More preferentially still, the compounds of formula (Ia) that are more particularly preferred are those in which R₁ represents —OCH₃, E represents a C1-C12 alkanediyl, preferably a C1-C10 alkanediyl, more preferentially a C1-C9 alkanediyl and X₁, X₂, X₃, which may be identical or different, are selected from the group consisting of a hydrogen atom, C1-C3 alkyls and phenyl, more preferentially X₁, X₂, X₃, which are identical, are a hydrogen atom. More preferentially still, the compounds of formula (Ia) that are more particularly preferred are those in which R₁ represents —OCH₃, E represents a C1-C9 alkanediyl and X₁, X₂, X₃, which are identical, are a hydrogen atom. More preferentially still, the compounds of formula (Ia) that are more particularly preferred are those in which R₁ represents —OCH₃, E represents a methanediyl, an ethanediyl or a propanediyl and X₁, X₂, X₃, which are identical, are a hydrogen atom. Among the compounds of formula (Ia), more particular preference is given to that of formula (Ia1):

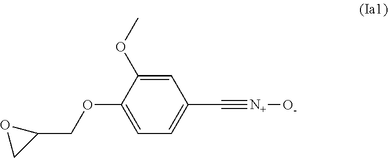

Surprisingly, the compounds of formula (I), more preferentially the compounds of formula (Ia), more preferentially still the compound of formula (Ia1), are compounds not having substitution in the ortho position relative to the nitrile oxide function and possessing, in addition to the epoxy group, an —OCH₃ or —OCH₂CH₃ group in the meta or para position. These compounds, once grafted onto a diene elastomer, confer the compositions based on said grafted elastomer with improved reinforcement properties compared to the prior art compositions. Surprisingly, the improvement in these reinforcement properties is not achieved at the expense of the rolling resistance/stiffness compromise. This compromise is even advantageously improved.

The compounds of formulae (I), (Ia) and (Ia1) may notably be obtained by a preparation process comprising at least a reaction (d) of a compound of formula (I) with an oxidizing agent in the presence of at least one organic solvent SL1 according to the following reaction scheme, to give the compound of formula (I), including the preferred forms (Ia) and (Ia1) thereof

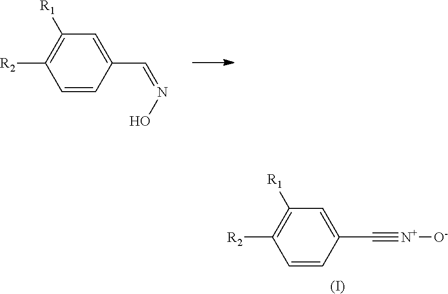

where:
   R₁ represents a chemical group selected from the group consisting of —OCH₃, —OCH₂CH₃ and —OR₃;
   R₂ represents a chemical group selected from the group consisting of —OCH₃ and —OR₃;
   provided that R₁ or R₂ is —OR₃;
   R₃ represents a chemical group of formula (II)

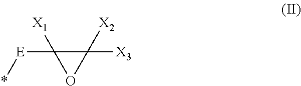

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol*represents the attachment of the group of formula (II) to the oxygen atom.

The preferred forms of R₁, R₂, E, X₁, X₂ and X₃ as described above also apply to the process for preparing a compound of formula (I) from a compound of formula (III).

Preferentially, the process for preparing a compound of formula (Ia) comprises at least a reaction (dl) of a compound of formula (IIIa) with an oxidizing agent in the presence of at least one organic solvent SL1 according to the following reaction scheme:

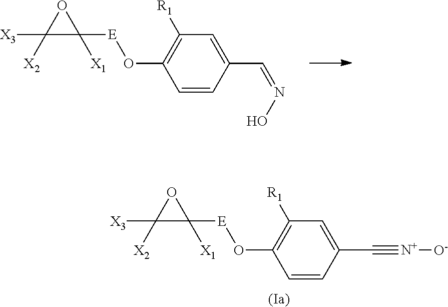

where R₁, R₂, E, X₁, X₂ and X₃ are as described above, including the preferred forms thereof, and R₁ represents a chemical group selected from the group consisting of —OCH₃ and —OCH₂CH₃, preferably R₁ is —OCH₃.

Preferably, in these processes, said oxidizing agent is selected from sodium hypochlorite, N-bromosuccinimide in the presence of a base, N-chlorosuccinimide in the presence of a base, and aqueous hydrogen peroxide solution in the presence of a catalyst. More preferentially, the oxidizing agent is selected from the group consisting of sodium hypochlorite and N-bromosuccinimide in the presence or absence of a base. Preferentially, the base may be triethylamine. More preferentially still, the oxidizing agent is sodium hypochlorite.

Advantageously, the amount of oxidizing agent is from 1 to 5 molar equivalents, preferentially from 1 to 2 molar equivalents, relative to the molar amount of the compound of formula (III), preferably of the compound of formula (IIIa).

Preferentially, the organic solvent SL1 is selected from chlorinated solvents and solvents of ester, ether and alcohol type, more preferentially selected from dichloromethane, trichloromethane, ethyl acetate, butyl acetate, diethyl ether, isopropanol and ethanol, more preferentially still selected from ethyl acetate, trichloromethane, dichloromethane and butyl acetate.

Preferably, the compound of formula (III), more preferentially the compound of formula (IIIa), represents from 1% to 30% by weight, preferably from 1% to 20% by weight, relative to the total weight of the combination comprising said compound of formula (III), preferably the compound of form (IIIa), said organic solvent SL1 and said oxidizing agent.

Preferentially, the process of the invention comprises, after the reaction (d) (preferably after the reaction (dl)), a step of recovering the compound of formula (I) (preferably of the compound of formula (Ia)).

The compound of formula (III) may notably be obtained from a preparation process comprising at least a reaction (c) of a compound of formula (IV) with hydroxylamine NH₂OH according to the following reaction scheme:

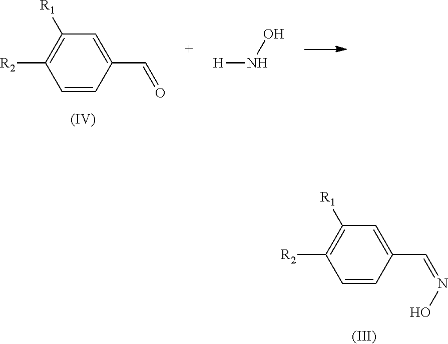

where:
   R₁ represents a chemical group selected from the group consisting of —OCH₃, —OCH₂CH₃ and —OR₃;
   R₂ represents a chemical group selected from the group consisting of —OCH₃ and —OR₃;
   provided that R₁ or R₂ is —OR₃;
   R₃ represents a chemical group of formula (II)

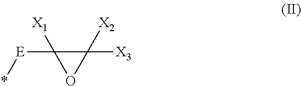

in which E represents a divalent C1-C12 hydrocarbon group optionally comprising one or more heteroatoms;
X₁, X₂, X₃, which may be identical or different, represent a hydrogen atom, a C1-C6 alkyl or a C6-C14 aryl;
the symbol*represents the attachment of the group of formula (II) to the oxygen atom.

The preferred forms of R₁, R₂, E, X₁, X₂ and X₃ as described above also apply to the process for preparing a compound of formula (III) from a compound of formula (IV).

Preferentially, the compound of formula (IIIa) may notably be obtained from a preparation process comprising at least a reaction (c1) of a compound of formula (IVa) with hydroxylamine NH₂OH according to the following reaction scheme:

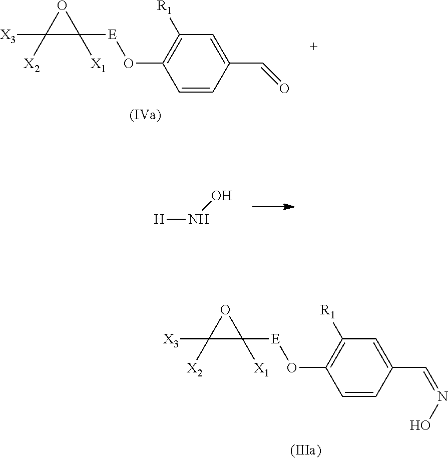

where E, X₁, X₂ and X₃ are as described above, including the preferred forms thereof, and R₁ represents a chemical group selected from the group consisting of —OCH₃ and —OCH₂CH₃, preferably R₁ is OCH₃.

Preferentially, the addition of hydroxylamine in reaction (c), preferably in reaction (c1), is carried out at a temperature ranging from 1° C. to 100° C., more preferentially between 20° C. and 70° C.

The hydroxylamine is added either in solution in water or in the form of a salt. When the hydroxylamine is in the form of a salt, it may be selected from the group consisting of hydroxylamine sulfate, hydroxylamine chloride and mixtures thereof. In the case of the use of hydroxylamine in the form of a salt, a base may preferentially be added to the reaction medium. As examples of a base, mention may be made of sodium acetate or triethylamine. The amount of base added may be within a range extending from 1 to 2 molar equivalents relative to the hydroxylamine generated, preferentially from 1 to 1.2 molar equivalents relative to the hydroxylamine generated. The term “hydroxylamine generated” is understood to mean the cation (NH₃⁺OH) of the hydroxylamine salt which is liberated when contacting said salt with water. When a base is used, said base is mixed with the hydroxylamine salt and the mixture is then dissolved in water. Preferentially, the hydroxylamine is brought into contact with the compound of formula (Ic) in the form of a hydroxylamine salt in the presence of a base, such as sodium acetate or triethylamine.

Preferentially, the process of the invention may comprise, after the reaction (c) (preferably after the reaction (c1)), a step of recovering the product of formula (III) (preferably of the product of formula (IIIa)).

The compound of formula (IV) may be obtained by a preparation process comprising at least a reaction (b) of the compound of formula (V) with a compound of formula (VI) in the presence of at least one phase transfer agent and at a temperature ranging from 10° C. to 120° C., preferentially from 20° C. to 100° C., according to the following reaction scheme:

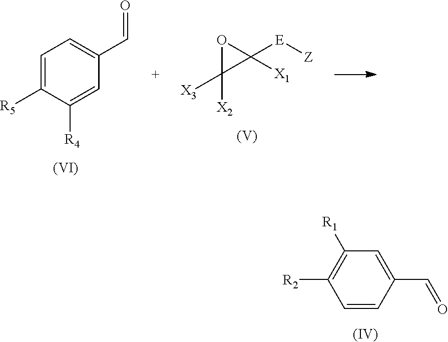

where for the compound of formula (VI):
   R₄ represents a chemical group selected from the group consisting of —OCH₃, —OCH₂CH₃ and —OH;
   R₅ represents a chemical group selected from the group consisting of —OCH₃ and —OH; and
   provided that R₄ or R₅ is —OH;
where for the compound of formula (V):
   E represents a divalent C1-C12 hydrocarbon group optionally comprising one or more heteroatoms; and
   X₁, X₂, X₃, which may be identical or different, represent a hydrogen atom, a C₁-C₆ alkyl or a C6-C14 aryl; and
   Z represents a nucleofugal group;
where for the compound of formula (IV): R₁ and R₂ are as defined above.

The preferred forms of R₁, R₂, E, X₁, X₂ and X₃ also apply to the process for preparing a compound of formula (IV) from compounds of formula (V) and compounds of formula (VI).

Preferentially, the compound of formula (IVa) may be obtained by a preparation process comprising at least a reaction (b1) of the compound of formula (V) with a compound of formula (VIa) in the presence of at least one phase transfer agent and at a temperature ranging from 10° C. to 120° C., preferentially from 20° C. to 100° C., according to the following reaction scheme:

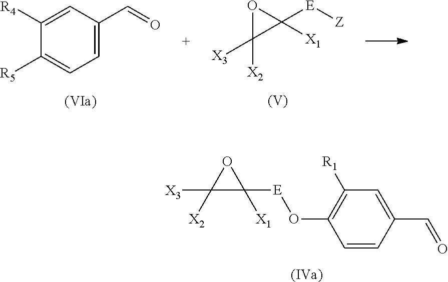

where for:
   the compound of formula (IVa), E, X₁, X₂, X₃, are as defined above, and R₁ represents a chemical group selected from the group consisting of —OCH₃ and —OCH₂CH₃; preferably R₁ is —OCH₃;
   the compound of formula (VIa):
      R₄ is —OCH₃ or —OCH₂CH₃, preferably —OCH₃, and
      R₅ is —OH,
   the compound of formula (V):
      E represents a divalent C1-C12 hydrocarbon group optionally comprising one or more heteroatoms; and
      X₁, X₂, X₃, which may be identical or different, represent a hydrogen atom, a C₁-C₆ alkyl or a C6-C14 aryl; and
      Z represents a nucleofugal group.

The term “nucleofugal group” is understood to mean a leaving group. The Z group may be selected from chlorine, bromine, iodine, fluorine, the mesylate group, the tosylate group, the acetate group and the trifluoromethylsulfonate group. Preferably, Z is bromine or chlorine. The phase transfer agent may be selected from phosphonium salts, ammonium salts and mixtures thereof. Preferentially, the phase transfer agent is tetrabutylammonium bromide. Preferentially, the molar amount of phase transfer agent is from 0.01 to 1 molar equivalents, preferably from 0.05 to 0.5 molar equivalents, relative to the molar amount of compound of formula (V).

Preferentially, the process of the invention may comprise, after the reaction (b) (preferably after the reaction (b1)), a step of recovering the product of formula (IV) (preferably of the product of formula (IVa)).

The compounds of formula (VI) as defined above are commercially available from suppliers such as Sigma-Aldrich, Merck, etc. They may be obtained by chemical synthesis, or, in the case of vanillin, by extraction from vanilla pods or, in the case of isovanillin, by extraction from cassava, or else obtained from fermentation by microorganisms, in particular by fermentation proceeding from ferulic acid.

The compounds of formula (V) may be commercially available or may be obtained by epoxidation of the corresponding haloalkene of formula (VII) according to the reaction scheme below. The synthesis of a compound comprising an epoxide ring from its corresponding alkene is well known. For example, this epoxidation may be performed in the presence of a peracid such as meta-chloroperbenzoic acid, peracetic acid or performic acid. Another well-known technique is the use of dimethyldioxirane.

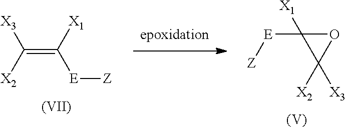

The compounds of formula (VII) are commercially available from suppliers such as Sigma-Aldrich and ABCR.

### Diene Elastomer:

The elastomeric composition of the invention comprises at least one diene elastomer, that is to say one or more diene elastomers, in particular one or more diene elastomers onto which the compound of formula (I), in particular the compound of formula (Ia), more particularly the compound of formula (Ia1), is optionally already grafted.

The term “diene elastomer” (or, without distinction, “diene rubber”), whether natural or synthetic, should be understood, in a known way, as meaning an elastomer consisting, at least in part (i.e., a homopolymer or a copolymer), of diene monomer units (monomers bearing two conjugated or non-conjugated carbon-carbon double bonds).

These diene elastomers can be classified into two categories: “essentially unsaturated” or “essentially saturated”. The term “essentially unsaturated” is generally understood to mean a diene elastomer derived at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may especially be termed “essentially saturated” diene elastomers (low or very low content, always less than 15% (mol %), of units of diene origin).

The term “diene elastomer that can be used in the context of the present invention” is understood particularly to mean:
any homopolymer of a conjugated or non-conjugated diene monomer having from 4 to 18 carbon atoms;
any copolymer of a conjugated or non-conjugated diene having from 4 to 18 carbon atoms and of at least one other monomer.

The other monomer can be ethylene, an olefin or a conjugated or non-conjugated diene. Suitable as conjugated dienes are conjugated dienes having from 4 to 12 carbon atoms, especially 1,3-dienes, such as, in particular, 1,3-butadiene and isoprene.

Suitable as non-conjugated dienes are non-conjugated dienes having from 6 to 12 carbon atoms, such as 1,4-hexadiene, ethylidenenorbornene or dicyclopentadiene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl) styrene.

Suitable as aliphatic α-monoolefins are in particular acyclic aliphatic α-monoolefins having from 3 to 18 carbon atoms.

More particularly, the diene elastomer is:
any homopolymer of a conjugated diene monomer, in particular any homopolymer obtained by polymerization of a conjugated diene monomer having from 4 to 12 carbon atoms;
any copolymer obtained by copolymerization of one or more conjugated dienes with each other or with one or more vinylaromatic compounds having from 8 to 20 carbon atoms;
a copolymer of isobutene and of isoprene (butyl rubber) and also the halogenated versions, in particular chlorinated or brominated versions, of this type of copolymer;
any copolymer obtained by copolymerization of one or more conjugated or non-conjugated dienes with ethylene, an α-monoolefin or a mixture thereof, such as, for example, the elastomers obtained from ethylene, from propylene with a non-conjugated diene monomer of the abovementioned type.

Preferentially, the diene elastomer is selected from the group consisting of ethylene/propylene/diene monomer (EPDM) copolymers, butyl rubbers, natural rubber (NR), synthetic polyisoprenes (IRs), polybutadienes (BRs), butadiene copolymers, isoprene copolymers and the mixtures of these elastomers.

Preferentially, the diene elastomer is selected from the group consisting of ethylene/propylene/diene monomer (EPDM) copolymers, natural rubber (NR), synthetic polyisoprenes (IRs), polybutadienes (BRs), butadiene/styrene copolymers (SBRs), ethylene/butadiene copolymers (EBRs), isoprene/butadiene copolymers (BIRs) or isoprene/butadiene/styrene copolymers (SBIRs), isobutene/isoprene copolymers (butyl rubber IIR), isoprene/styrene copolymers (SIRs), and mixtures of these elastomers.

Preferentially, the diene elastomer is selected from the group consisting of natural rubber, synthetic polyisoprenes, polybutadienes, butadiene copolymers, isoprene copolymers and mixtures of these elastomers.

More preferentially, the diene elastomer is selected from the group consisting of natural rubber, synthetic polyisoprenes, polybutadienes, butadiene/styrene copolymers, ethylene/butadiene copolymers, isoprene/butadiene copolymers, isoprene/butadiene/styrene copolymers, isobutene/isoprene copolymers, isoprene/styrene copolymers, and mixtures of these elastomers. The diene elastomers can have any microstructure which depends on the polymerization conditions used. These diene elastomers may be, for example, block, random, sequential or microsequential elastomers and may be prepared in dispersion, in emulsion or in solution. They may be coupled and/or star-branched, for example by means of a silicon or tin atom which connects the polymer chains together. They are preferably random diene elastomers. As seen above, the elastomeric composition according to the invention is based on at least one diene elastomer and on at least one compound of formula (I), in particular on at least one compound of formula (Ia), more particularly on at least one compound of formula (Ia1), optionally already grafted onto the diene elastomer. The diene elastomer may be grafted by the compound of formula (I), in particular by the compound of formula (Ia), more particularly by the compound of formula (Ia1), prior to the introduction thereof into the elastomeric composition, or else may be grafted by reaction with the compound of formula (I), in particular with that of formula (Ia), more particularly with that of formula (Ia1), during the manufacture of the elastomeric composition.

When the elastomeric composition comprises at least one diene elastomer grafted beforehand by the compound of formula (I), in particular by the compound of formula (Ia), more particularly by the compound of formula (Ia1), the molar degree of grafting of the compound of formula (I) onto said diene elastomer, in particular of the compound of formula (Ia), in particular of the compound of formula (Ia1), is within a range extending from 0.05% to 15%, preferably from 0.05% to 10%, more preferentially from 0.07% to 5%. In the embodiment in which the diene elastomer is grafted by reaction with the compound of formula (I), in particular with that of formula (Ia), more particularly with that of formula (Ia1), during the manufacture of the elastomeric composition, then the content of the compound of formula (I), in particular the content of the compound of formula (Ia), more particularly the content of the compound of formula (Ia1), in the elastomeric composition according to the invention is within a range extending from 0.01 to 15 phr.

The elastomeric composition according to the invention may contain a single diene elastomer grafted by the compound of formula (I), in particular by the compound of formula (Ia), more particularly by the compound of formula (Ia1), (either grafted prior to the introduction thereof into the elastomeric composition, or grafted by reaction with said compound of formula (I), in particular with said compound of formula (Ia), more particularly with said compound of formula (Ia1), during the manufacture of the elastomeric composition), or a mixture of several grafted diene elastomers, or a mixture of several diene elastomers of which some are grafted but not others.

The other diene elastomer(s) used as a mixture with the grafted diene elastomer are diene elastomers as described above, whether star-branched, coupled, functionalized or non-functionalized.

In the case of a mixture with at least one other diene elastomer, the grafted diene elastomer is the predominant elastomer in the elastomeric composition. It should be noted that the improvement in the properties of the elastomeric composition according to the invention will be greater as the proportion of said additional elastomer(s) in the elastomeric composition according to the invention becomes lower.

The grafted diene elastomer(s) can be used in combination with any type of synthetic elastomer other than a diene elastomer, indeed even with polymers other than elastomers, for example with thermoplastic polymers.

### Reinforcing Filler

As seen above, another component of the elastomeric composition according to the invention is a reinforcing filler.

Use may be made of any type of “reinforcing” filler known for its abilities to reinforce an elastomeric composition which can be used in particular for the manufacture of tyres, for example an organic filler, such as carbon black, a reinforcing inorganic filler, such as silica, or else a mixture of these two types of fillers.

Advantageously, the reinforcing filler is selected from carbon black, a reinforcing inorganic filler, and mixtures thereof.

Suitable carbon blacks include all carbon blacks, notably the blacks conventionally used in tyres or their treads. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated into the diene elastomer, in particular an isoprene elastomer, in the form of a masterbatch (see, for example, patent applications WO 97/36724-A2 and WO 99/16600-A1). For carbon blacks, the STSA specific surface area is determined according to the standard ASTM D6556-2016.

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, which is capable of reinforcing, by itself alone, without means other than an intermediate coupling agent, an elastomeric composition intended for the manufacture of tyres. In a known manner, some reinforcing inorganic fillers may in particular be characterized by the presence of hydroxyl (—OH) groups at their surface.

Suitable in particular as reinforcing inorganic fillers are mineral fillers of the siliceous type, preferentially silica (SiO₂), or of the aluminous type, in particular alumina (Al₂O₃).

The silica used may be any reinforcing silica known to those skilled in the art, in particular any precipitated or fumed silica with a BET specific surface area and also a CTAB specific surface area both of less than 450 m²/g, preferably within a range extending from 30 to 400 m²/g.

Use may be made of any type of precipitated silica, in particular highly dispersible precipitated silicas (HDS, for “highly dispersible silicas”). These precipitated silicas, which may or may not be highly dispersible, are well known to a person skilled in the art. Mention may be made, for example, of the silicas described in patent applications WO 03/016215-A1 and WO 03/016387-A1. Among the commercial HDS silicas, use may notably be made of the Ultrasil® 5000GR and Ultrasil® 7000GR silicas from the company Evonik or the Zeosil® 1085GR, Zeosil® 1115 MP, Zeosil® 1165MP, Zeosil® Premium 200MP and Zeosil® HRS 1200 MP silicas from the company Solvay. Use may be made, as non-HDS silica, of the following commercial silicas:

the Ultrasil® VN2GR and Ultrasil® VN3GR silicas from the company Evonik, the Zeosil® 175GR silica from the company Solvay or the Hi-Sil EZ120G (-D), Hi-Sil EZ160G (-D), Hi-Sil EZ200G (-D), Hi-Sil 243LD, Hi-Sil 210 and Hi-Sil HDP 320G silicas from the company PPG. In the present disclosure, the BET specific surface area for the inorganic filler, in particular for the silica, is determined by gas adsorption using the Brunauer-Emmett-Teller method described in “The Journal of the American Chemical Society” (Vol. 60, page 309, February 1938), and more specifically according to a method adapted from the standard NF ISO 5794-1, appendix E, of June 2010 [multipoint (5 point) volumetric method-gas: nitrogen-degassing under vacuum: one hour at 160° C.-relative pressure p/po range: 0.05 to 0.17]. The CTAB specific surface area values were determined according to the standard NF ISO 5794-1, appendix G of June 2010. The process is based on the adsorption of CTAB (N-hexadecyl-N,N,N-trimethylammonium bromide) on the “outer” surface of the reinforcing filler.

When a reinforcing inorganic filler is used in the elastomeric composition according to the invention, especially if said filler is silica, this reinforcing inorganic filler preferentially has a BET surface area which is within a range extending from 45 to 400 m²/g, more preferentially within a range extending from 60 to 300 m²/g.

The physical state in which the reinforcing inorganic filler is provided is not important, whether it be in the form of a powder, micropearls, granules, or beads or any other appropriate densified form. Needless to say, the term “reinforcing inorganic filler” is understood also to mean mixtures of different reinforcing inorganic fillers, in particular of silicas as described above.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer.

Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (symmetrical or asymmetrical), such as bis(3-triethoxysilylpropyl) tetrasulfide, abbreviated to TESPT, sold under the name Si69 by the company Evonik, or bis(triethoxysilylpropyl) disulfide, abbreviated to TESPD, sold under the name Si75 by the company Evonik, polyorganosiloxanes, mercaptosilanes, blocked mercaptosilanes, such as S-(3-(triethoxysilyl) propyl) octanethioate, sold by the company Momentive under the name NXT Silane. More preferentially, the organosilane is an organosilane polysulfide.

Needless to say, use might also be made of mixtures of the coupling agents described above. The content of coupling agent in the elastomeric composition is advantageously less than or equal to 35 phr, it being understood that it is generally desirable to use as little as possible thereof. Typically, the content of coupling agent represents from 0.5% to 15% by weight, relative to the amount of reinforcing inorganic filler.

A person skilled in the art will understand that, as replacement for the reinforcing inorganic filler described above, use might be made of a reinforcing filler of another nature, provided that this reinforcing filler of another nature is covered with an inorganic layer, such as silica, or else comprises functional sites, in particular hydroxyl sites, at its surface which require the use of a coupling agent in order to establish the bond between this reinforcing filler and the diene elastomer. By way of example, mention may be made of carbon blacks partially or totally covered with silica, or carbon blacks modified with silica, such as, but not limited to, fillers of the Ecoblack® type in the CRX2000 series or in the CRX4000 series from the company Cabot Corporation.

A person skilled in the art will know how to adjust the content of reinforcing filler in the elastomeric composition of the invention according to the use concerned, in particular according to the type of tyres concerned, for example a tyre for a motorbike, for a passenger vehicle or for a utility vehicle, such as a van or heavy-duty vehicle. Preferably, this content of reinforcing filler is within a range extending from 10 to 200 phr, more preferentially from 20 to 180 phr, more preferentially from 30 to 120 phr, the optimum being, in a known way, different according to the specific applications targeted.

According to one embodiment, the reinforcing filler comprises predominantly at least one silica; it preferably consists essentially of silica, and more preferentially still consists of silica. In this embodiment where the reinforcing filler comprises predominantly at least one silica, the content of carbon black present in the elastomeric composition is preferentially within a range extending from 2 to 20 phr.

According to another embodiment of the invention, the reinforcing filler comprises predominantly carbon black, indeed even consists essentially of carbon black and more preferentially still consists of carbon black.

According to a preferred embodiment, the composition comprises at least one diene elastomer selected from the group consisting of natural rubber, synthetic polyisoprenes, polybutadienes, butadiene copolymers, isoprene copolymers and mixtures of these elastomers, and at least one reinforcing filler, said reinforcing filler comprising predominantly at least one silica. More preferentially still, the composition comprises at least one diene elastomer selected from the group consisting of natural rubber, synthetic polyisoprenes, ethylene/butadiene copolymers, styrene/butadiene copolymers and at least one reinforcing filler, said reinforcing filler comprising predominantly at least one silica.

### Crosslinking Agent

Another component of the elastomeric composition according to the invention is a crosslinking agent. The crosslinking agent allows the formation of covalent bonds between the diene elastomer chains, thereby conferring elastic properties thereon.

The crosslinking agent can be any type of system known to a person skilled in the art in the field of elastomeric compositions for tyres. It may in particular be based on sulfur or based on peroxides. Preferentially, the crosslinking system is based on sulfur.

Preferentially, the crosslinking agent is based on sulfur; it is then called a vulcanization system. The sulfur can be provided in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

Sulfur is used in a preferential content of between 0.5 and 12 phr, in particular between 1 and 10 phr. The vulcanization accelerator is used in a preferential content of between 0.5 and 10 phr, more preferentially of between 0.5 and 5.0 phr.

Use may be made, as accelerator, of any compound that is capable of acting as an accelerator for the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate type. Mention may in particular be made, by way of examples of such accelerators, of the following compounds:

2-mercaptobenzothiazyl disulfide (abbreviated “MBTS”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), tetrabenzylthiuram disulfide (“TBZTD”), zinc dibenzyldithiocarbamate (“ZBEC”) and mixtures of these compounds.

### Other Additives:

The elastomeric compositions of the invention can also comprise all or some of the usual additives and processing aids known to a person skilled in the art and generally used in elastomeric compositions for tyres, in particular treads, such as, for example, plasticizers (such as plasticizing oils and/or plasticizing resins), non-reinforcing fillers, pigments, protective agents, such as antiozone waxes, chemical antiozonants, antioxidants, anti-fatigue agents or reinforcing resins (such as described, for example, in application WO 02/10269).

### Process for Manufacturing the Compositions

A process for preparing the elastomeric composition defined above is also described.

The elastomeric composition of the invention is manufactured in appropriate mixers, using two successive known phases of preparation:
a first phase of thermomechanical working or kneading (“non-productive” phase) conducted at a maximum temperature within a range extending from 110° C. to 200° C., preferably from 130° C. to 185° C., for a duration of generally within a range extending from 2 to 10 minutes,
a second phase of mechanical working (“productive” phase), which is carried out in an external mixer, such as an open mill, after cooling the mixture obtained during the first non-productive phase down to a lower temperature, typically of less than 120° C., for example within a range extending from 40° C. to 100° C. The crosslinking agent is then incorporated and the combined mixture is mixed for a few minutes, for example within a range extending from 5 to 15 min.

Generally, all the base constituents of the elastomeric composition of the invention, with the exception of the chemical crosslinking agent, namely the reinforcing filler(s) and the coupling agent, if appropriate, are intimately incorporated, by kneading, into the diene elastomer or into the diene elastomers during the first “non-productive” phase, that is to say that at least these various base constituents are introduced into the mixer and are thermomechanically kneaded, in one or more steps, until the maximum temperature of between 110° C. and 200° C., preferably of between 130° C. and 185° C., is reached.

According to a first embodiment of the compositions, the diene elastomer has been grafted by the compound of formula (I), in particular by the compound of formula (Ia), more particularly still by the compound of formula (Ia1), prior to the manufacture of the elastomeric composition. Thus, in this case, it is the grafted diene elastomer which is introduced during the first “non-productive” phase. Thus, according to this first embodiment of the process, the latter comprises the following steps:
modifying the diene elastomer by solution or bulk grafting with at least one compound of formula (I), in particular with at least one compound of formula (Ia), more particularly with at least one compound of formula (Ia1) as defined above,
incorporating, into the diene elastomer grafted in this way by the compound of formula (I), in particular by the compound of formula (Ia), more particularly by the compound of formula (Ia1), the reinforcing filler and all the base constituents of the composition, with the exception of the crosslinking agent, by thermomechanically kneading the mixture, once or several times, until a maximum temperature within a range extending from 110° C. to 200° C., preferably from 130° C. to 185° C., is reached,
cooling the preceding mixture to a temperature below 100° C.,
then incorporating the crosslinking agent,
kneading the mixture obtained in the previous step up to a temperature of less than 120° C.

The diene elastomer is grafted by reacting said diene elastomer with the nitrile oxide function of the compound of formula (I), in particular with the nitrile oxide of the compound of formula (Ia), more particularly with the nitrile oxide of the compound of formula (Ia1). During this reaction, this nitrile oxide forms a covalent bond with the chain of said diene elastomer. More precisely, the grafting of the compound of formula (I), in particular of the compound of formula (Ia), more particularly still of the compound of formula (Ia1), is carried out by [3+2] cycloaddition of the nitrile oxide function with an unsaturation of the chain of the initial diene elastomer. A mechanism of the [3+2] cycloaddition is described in the document WO2012/007441.

The diene elastomer bears, along the main elastomer chain, one or more pendent groups derived from the grafting reaction of the compound of formula (I), in particular of the compound of formula (Ia), more particularly of the compound of formula (Ia1), as defined above. Advantageously, these pendent groups are distributed randomly along the main elastomer chain.

The grafting of the compound of formula (I), in particular of the compound of formula (Ia), more particularly of the compound of formula (Ia1), may be carried out in bulk, for example in an internal mixer or an external mixer, such as an open mill. The grafting is then performed either at a temperature of the external mixer or of the internal mixer of less than 60° C., followed by a step of grafting reaction under a press or in an oven at temperatures ranging from 80° C. to 200° C., or at a temperature of the external mixer or of the internal mixer of greater than 60° C., without subsequent heat treatment.

The grafting process may also be performed in solution, continuously or batchwise. The diene elastomer thus grafted may be separated from its solution by any type of known means, in particular by a steam stripping operation.

According to a second embodiment of the compositions, the grafting of the diene elastomer by the compound of formula (I), in particular by the compound of formula (Ia), more particularly by the compound of formula (Ia1), is performed concomitantly with the manufacture of the elastomeric composition. In this case, both the not-yet-grafted diene elastomer and the compound of formula (I), in particular the compound of formula (Ia), more particularly the compound of formula (Ia1), are introduced during the first “non-productive” phase. Preferentially, the reinforcing filler is then added subsequently, during this same non-productive phase, in order to prevent any side reaction with the compound of formula (I), in particular with the compound of formula (Ia), more particularly with the compound of formula (Ia1).

Thus, according to this second embodiment of the preferred process, the latter comprises the following steps:
incorporating, into the diene elastomer, at least one compound of formula (I), in particular at least one compound of formula (Ia), more particularly at least one compound of formula (Ia1), as defined above, and, preferably subsequently, the reinforcing filler along with all the base constituents of the composition, with the exception of the chemical crosslinking agent, by thermomechanically kneading the mixture, once or several times, until a maximum temperature within a range extending from 110° C. to 200° C., preferably from 130° C. to 185° C., is reached;
cooling the mixture obtained in the preceding step to a temperature below 100° C.,
then incorporating the crosslinking agent,
kneading the mixture obtained in the preceding step up to a maximum temperature of less than 120° C.

In these two preferred embodiments, the molar degree of grafting of the compound of formula (I), in particular of the compound of formula (Ib), more particularly of the compound of formula (III), is in a range extending from 0.01% to 15%, preferably from 0.05% to 10%, more preferentially from 0.07% to 5%.

The term “molar degree of grafting” is understood to mean the number of moles of the compound of formula (I), in particular of the compound of formula (Ia), in particular of the compound of formula (Ia1), grafted onto the diene elastomer per 100 mol of monomer unit constituting the diene elastomer. The molar degree of grafting can be determined by conventional polymer analysis methods, for instance ¹H NMR analysis.

The final elastomeric composition thus obtained can subsequently be calendered, for example in the form of a sheet or a slab, especially for characterization, or else extruded in the form of a rubber profiled element which can be used as semi-finished article for a tyre.

Another subject of the present invention is a semi-finished article for a tyre comprising at least one elastomeric composition as defined above; the semi-finished article for a tyre is preferably a tyre tread.

A subject of the invention is also a tyre comprising at least one elastomeric composition according to the invention as defined above, preferably in all or part of its tread, or comprising at least one semi-finished article for a tyre.

The tyre according to the invention will preferentially be able to be selected from tyres intended to equip a two-wheeled vehicle, a passenger vehicle, or else a “heavy-duty” vehicle (that is to say, underground trains, buses, off-road vehicles, heavy road transport vehicles, such as trucks, tractors or trailers), or else aircraft, civil engineering vehicles, heavy agricultural vehicles or handling vehicles.

The examples which follow make it possible to illustrate the invention; however, the invention shall not be limited to these examples alone.

### EXAMPLES

### 1. Methods

### 1.1 Measurement of the Number-Average (Mn) and Weight-Average (Mw) Molar Masses and of the Polydispersity Index of the Elastomers

Size exclusion chromatography (SEC) is used. SEC makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of an elastomer. The various number-average molar masses (Mn) and weight-average molar masses (Mw) may be determined from commercial standards and the polydispersity index (PDI=Mw/Mn) may be calculated via a “Moore” calibration.

### Preparation of the Elastomer Sample to be Tested

There is no specific treatment of the elastomer sample before analysis. The latter is simply dissolved, at a concentration of approximately 1 g/l, in chloroform or in the following mixture: tetrahydrofuran+1 vol % of diisopropylamine+1 vol % of triethylamine+1 vol % of distilled water (vol %=% by volume). The solution is then filtered through a filter with a porosity of 0.45 μm before injection.

### SEC Analysis

The apparatus used is a Waters Alliance chromatograph. The elution solvent is the following mixture: tetrahydrofuran+1 vol % of diisopropylamine+1 vol % of triethylamine or chloroform, according to the solvent used for the dissolution of the elastomer. The flow rate is 0.7 ml/min, the temperature of the system is 35° C. and the analysis time is 90 min. A set of four Waters columns in series, having the commercial names Styragel HMW7, Styragel HMW6E and two Styragel HT6E, is used.

The volume of the solution of the elastomer sample injected is 100 μl. The detector is a Waters 2410 differential refractometer with a wavelength of 810 nm. The software for processing the chromatographic data is the Waters Empower system. The calculated average molar masses are relative to a calibration curve produced from PSS Ready Cal-Kit commercial polystyrene standards.

### 1.2. Characterizations of the Molecules

The structural analysis and the determination of the molar purities of the molecules synthesized are performed by NMR analysis. The spectra are acquired on a Bruker Avance 3 400 MHZ spectrometer equipped with a “5 mm BBFO Z-grad broad band” probe. The quantitative 1H NMR experiment uses a 30° single pulse sequence and a repetition time of 3 seconds between each of the 64 acquisitions. The samples are dissolved in a deuterated solvent, deuterated dimethyl sulfoxide (DMSO) unless otherwise indicated. The deuterated solvent is also used for the “lock” signal. For example, calibration is performed on the signal of the protons of the deuterated DMSO at 2.44 ppm relative to a TMS reference at 0 ppm. The ¹H NMR spectrum coupled with the 2D ¹H/¹³C HSQC and ¹H/¹³C HMBC experiments enable the structural determination of the molecules (cf. assignment tables). The molar quantifications are carried out from the quantitative 1D ¹H NMR spectrum.

The analysis by mass spectrometry is carried out by a direct-injection electrospray ionization method (DI/ESI). The analyses were carried out on a Bruker HCT spectrometer (flow rate 600 μl/min, pressure of the nebulizer gas 10 psi, flow rate of the nebulizer gas 41/min).

1.3. Characterizations of the Compounds Grafted onto the Diene Elastomers

The determination of the molar content of the compounds grafted onto the diene elastomers is performed by an NMR analysis. The spectra are acquired on a Bruker 500 MHz spectrometer equipped with a “5 mm BBFO Z-grad CryoProbe” probe. The quantitative ¹H NMR experiment uses a 30° single pulse sequence and a repetition time of 5 seconds between each acquisition. The samples are dissolved in deuterated chloroform (CDCl₃) for the purpose of obtaining a “lock” signal. 2D NMR experiments made it possible to confirm the nature of the grafted unit by means of the chemical shifts of the carbon atoms and protons.

### 1.4. Dynamic Properties of the Elastomeric Compositions

The dynamic properties G* and tan(8) max are measured on a viscosity analyser (Metravib VA4000) according to the standard ASTM D5992-96. The response of a sample of vulcanized composition (cylindrical test specimen 4 mm thick and 400 mm² in cross section), subjected to a simple alternating sinusoidal shear stress, at a frequency of 10 Hz, at a temperature of 60° C., is recorded. A strain amplitude sweep is carried out from 0.1% to 100% peak-peak (outward cycle) and then from 100% to 0.1% peak-peak (return cycle).

The results utilized are the complex dynamic shear modulus G* at 50% strain (G*₅₀% return) and the dynamic loss factor tan(δ) at 60° C. For the return journey, the value of the complex dynamic shear modulus G* at 50% strain, denoted G*_{50% return at 60° C.}, and the maximum value of the dynamic loss factor tan(δ) observed, denoted tan(δ)_{max at 60° C.}, are recorded.

The results are shown in base 100, the arbitrary value 100 being assigned to the control in order to calculate and subsequently compare tan(δ)_{max at 60° C.} and G*_{50% return at 60° C.}

For tan(δ)_{max at 60° C.}, the value in base 100 for the sample to be tested is calculated according to the operation: (tan(δ)_{max at 60° C.} value of the sample to be tested/tan(δ)_{max at 60° C.} value of the control)×100. In this way, a result of less than 100 indicates a decrease in the hysteresis, which corresponds to an improvement in the rolling resistance performance.

For G*_{50% return at 60° C.}, the value in base 100 for the sample to be tested is calculated according to the operation: (G*_{50% return at 60° C.} value of the sample to be tested/G*_{50% return at 60° C.} value of the control)×100. In this way, a result of greater than 100 indicates an improvement in the complex dynamic shear modulus G*_{50% return at 60° C.}, which corroborates an improvement in the stiffness of the material.

### 1.5. Tensile Test

These tensile tests make it possible to determine the elasticity stresses. Unless otherwise indicated, they are performed in accordance with the French standard NF T46-002 of September 1988. Processing the tensile recordings also makes it possible to plot the curve of modulus as a function of the elongation. At first elongation, the nominal secant modulus, calculated by normalizing to the initial cross section of the test specimen, (or apparent stress, in MPa) is measured at 100% elongation, denoted MSA100, and at 300% elongation, denoted MSA300. All these tensile measurements are performed under the standard temperature conditions (23±2° C.) according to the standard NF T46-002 and at a temperature of 100° C.

The MSA300/MSA100 ratio is the reinforcement index. The value in base 100 for the sample to be tested is calculated according to the operation: (MSA300/MSA100 value of the sample to be tested/MSA300/MSA100 value of the control)×100. In this way, a result of greater than 100 indicates an improvement in the reinforcement index.

### 2. Synthesis of the Compounds

2.1. Synthesis of 3-methoxy-4-(oxiran-2-ylmethoxy)benzonitrile oxide (Compound A)

Compound A is synthesized according to the following reaction scheme:

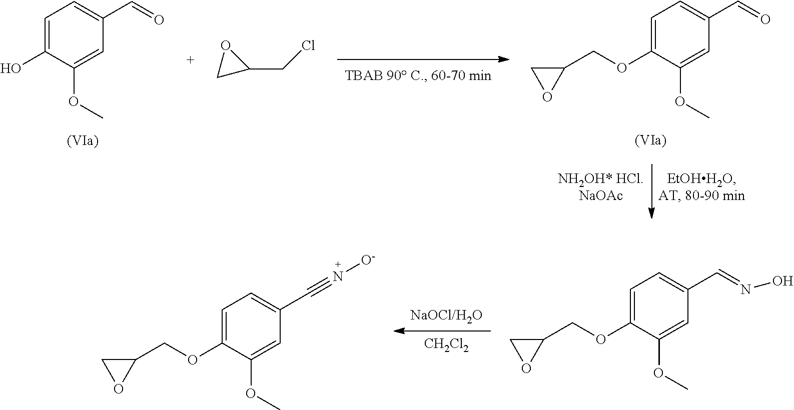

The vanillin is obtained from the company Sigma-Aldrich, which sells it under the reference “W310700-1 KG”.

2.1.1. Step 1: Synthesis of 3-methoxy-4-(oxiran-2-ylmethoxy)benzaldehyde

To a solution of vanillin (20 g; 131 mmol) in epichlorohydrin (278 ml; 3.56 mol, i.e. 27 eq. (eq.=molar equivalent)) is added tetrabutylammonium bromide (4.24 g; 13.15 mmol, i.e. 0.1 eq.). The reaction medium is then stirred for 60-70 minutes at a temperature of 90° C. After returning to ambient temperature, the reaction mixture is diluted with ethyl acetate (150 ml), washed with brine (3×75 ml) and lastly with distilled water (75 ml). The organic phase is then separated, dried over sodium sulfate and evaporated under reduced pressure (T bath=50° C.; 13 mbar). The oil obtained is triturated with ice-cold isopropyl alcohol (i-PrOH) (50 ml), allowing rapid crystallization. The precipitate is filtered off and washed with ice-cold i-PrOH (3×35 ml); and then dried in air.

A white solid (23.16 g; 111 mmol) is obtained with a yield of 85%. The molar purity is greater than 90% (¹H NMR).

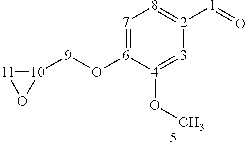

TABLE 1

| No. | δ ¹H (ppm) | δ ¹³C (ppm) |
|---|---|---|
| 1 | 9.80 | 190.9 |
| 2 | / | 130.6 |
| 3 | 7.36 | 109.4 |
| 4 | / | 149.9 |
| 5 | 3.88 | 56.0 |
| 6 | / | 153.3 |
| 7 | 6.97 | 112.2 |
| 8 | 7.38 | 126.5 |
| 9 | 4.04 and 4.33 | 69.9 |
| 10 | 3.37 | 49.8 |
| 11 | 2.73 and 2.88 | 44.7 |

Solvent CDCl₃

2.1.2 Step 2: Synthesis of 3-methoxy-4-(oxiran-2-ylmethoxy)benzaldehyde oxime

To a suspension of 3-methoxy-4-(oxiran-2-ylmethoxy)benzaldehyde (4.253 g; 20.43 mmol) in ethanol (100 ml) is added, at ambient temperature (23° C.), a solution of sodium acetate (2.51 g; 30.6 mmol, i.e. 1.5 eq.) and of hydroxylamine hydrochloride (2.129 g; 30.6 mmol, i.e. 1.5 eq.) in distilled water (100 ml). After complete dissolution in 40-50 seconds, a slight exothermicity is observed within the reaction medium. A new precipitate forms within a few minutes. The reaction mixture is then stirred at ambient temperature for 90 minutes. Crushed ice (100 g) is then added and the medium is maintained under stirring until the crushed ice has completely melted. The precipitate is lastly filtered off, washed with an excess of water and dried in air. A white solid (3.604 g; 16.14 mmol; 79% yield) is obtained. The molar purity is greater than 89% (¹H NMR).

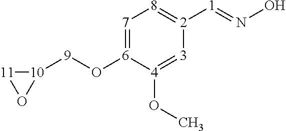

TABLE 2

| No. | δ ¹H (ppm) | δ ¹³C (ppm) |
|---|---|---|
| 1 | 8.00 | 150.2 |
| 2 | / | 126.0 |
| 3 | 6.95 | 121.5 |
| 4 | 6.86 | 113.6 |
| 5 | / | 149.9 |
| 6 | / | 150.0 |
| 7 | 7.17 | 108.9 |
| 8 | 3.84 | 56.0 |
| 9 | 4.00 and 4.22 | 70.2 |
| 10 | 3.33 | 50.1 |
| 11 | 2.69 and 2.84 | 44.9 |

Solvent: CDCl₃

2.1.3 Step 3: Synthesis of 3-methoxy-4-(oxiran-2-ylmethoxy)benzonitrile N-oxide

To a suspension of 3-methoxy-4-(oxiran-2-ylmethoxy)benzaldehyde oxime (10.15 g; 45.5 mmol) in dichloromethane (100 ml) cooled to 0-3° C. is added, dropwise, a solution of bleach (98.5 ml; 4% active chlorine) (bleach=sodium hypochlorite) over 20-25 minutes. The reaction medium is then stirred for 80-90 minutes between 0 and 5° C. The organic phase is then separated, washed with water (2×50 ml) and lastly evaporated under reduced pressure (T bath=25° C.; 10 mbar) to afford a beige solid. This solid is then redissolved in dichloromethane (˜100 ml). The solution obtained above is then filtered through a layer of SiO₂ (about 4-5 cm thick), eluting with dichloromethane (2×30 ml). The permeate is lastly concentrated under reduced pressure (T bath=25° C.; 10 mbar) to afford a white solid obtained with a yield of 71% (7.126 g; 32.2 mmol). The molar purity is 95% (¹H NMR).

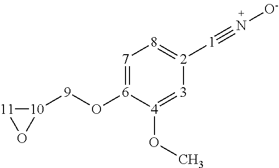

TABLE 3

| No. | δ ¹H (ppm) | δ ¹³C (ppm) |
|---|---|---|
| 1 | / | / |
| 2 | / | 106.1 |
| 3 | 7.04 | 125.8 |
| 4 | 6.87 | 114.0 |
| 5 | / | 150.7 |
| 6 | / | 150.0 |
| 7 | 6.92 | 115.0 |
| 8 | 3.82 | 56.2 |
| 9 | 3.98 and 4.27 | 70.2 |
| 10 | 3.32 | 49.9 |
| 11 | 2.69 and 2.85 | 44.7 |

Solvent: CDCl₃

2.2. Synthesis of 2-(glycidyloxy)-1-naphthonitrile oxide (Compound B)

2-(Glycidyloxy)-1-naphthonitrile oxide, compound B, is synthesized according to the procedure described in patent application US 2012/0046418 A1 paragraphs to [0037].

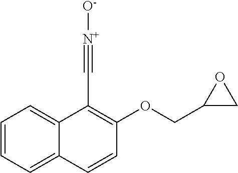 [SMILES: [O-][N+]#Cc1c(OCC2CO2)ccc2ccccc12]

2.3 Synthesis of 2,4,6-trimethyl-3-(oxiran-2-ylmethoxy)benzonitrile oxide (Compound C)

2,4,6-Trimethyl-3-(oxiran-2-ylmethoxy)benzonitrile oxide, compound C, is synthesized according to the reaction scheme and synthesis process described below and obtained from the examples of document WO2019102128:

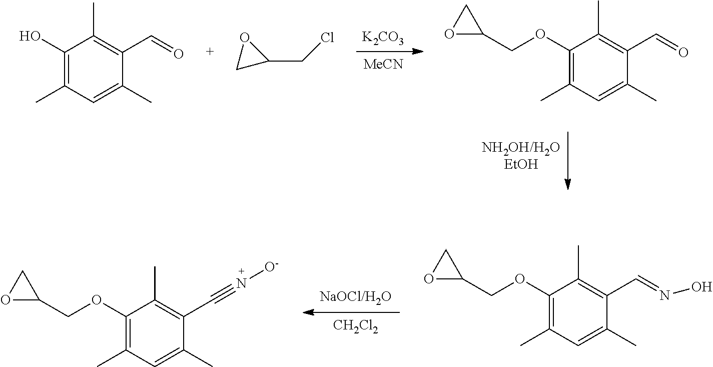

2.3.1. Synthesis of 2,4,6-trimethyl-3-(oxiran-2-ylmethoxy)benzaldehyde:

To a mixture of 3-hydroxy-2,4,6-trimethylbenzaldehyde (40.00 g; 0.244 mol) and epichlorohydrin (56.35 g; 0.609 mol) in acetonitrile (100 ml) is added potassium carbonate (50.50 g; 0.365 mol). The reaction medium is stirred for 3 hours at 60° C. and is then stirred for 2.5-3 hours at 70° C. After returning to 40-50 C, the reaction mixture is diluted with a mixture of water (250 ml) and ethyl acetate (250 ml) and then maintained under stirring for 10 minutes. The organic phase is separated and washed with water (4 times with 125 ml). The solvent is evaporated under reduced pressure (T bath 37° C.; 40 mbar). A red oil (66.43 g) is obtained. The byproduct of the reaction, 3,3′-((2-hydroxypropane-1,3-diyl)bis(oxy))bis(2,4,6-trimethylbenzaldehyde), is separated from 2,4,6-trimethyl-3-(oxiran-2-ylmethoxy)benzaldehyde by chromatography on a silica column (eluent: ethyl acetate/petroleum ether=¼ by volume). After recovery of the fractions containing 2,4,6-trimethyl-3-(oxiran-2-ylmethoxy)benzaldehyde, the solvents are evaporated under reduced pressure (T bath 36° C.; 21 mbar). Petroleum ether (120 ml) is added to the residue and the suspension is maintained under stirring at −18° C. for 2 hours. The precipitate is filtered off, washed on the filter with petroleum ether (40/60) (3 times 25 ml) and lastly dried under atmospheric pressure at ambient temperature for 10-15 hours. A white solid (40.04 g; yield by mass of 75%) with a melting point of 52° C. is obtained. The molar purity is greater than 99% (¹H NMR).

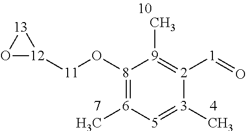

TABLE 4

| | δ ¹H (ppm) | δ ¹³C (ppm) |
|---|---|---|
| 1 | 10.37 | 193.3 |
| 2 | / | 131.1 |
| 3 | / | 132.8 |
| 4 | 2.4 | 19.2 |
| 5 | 6.94 | 131.3 |
| 6 | / | 136.3 |
| 7 | 2.2 | 16.1 |
| 8 | / | 153.4 |
| 9 | / | 135.7 |
| 10 | 2.4 | 11.7 |
| 11 | 3.50/4.00 | 73.4 |
| 12 | 3.29 | 49.6 |
| 13 | 2.60/2.76 | 42.9 |

Solvent DMSO

2.3.2 Synthesis of 2,4,6-trimethyl-3-(oxiran-2-ylmethoxy)benzaldehyde oxime:

To a solution of 2,4,6-trimethyl-3-(oxiran-2-ylmethoxy)benzaldehyde (46.70 g; 0.212 mol) in ethyl alcohol (750 ml) is added, at ambient temperature, a solution of hydroxylamine (16.81 g; 0.254 mol, 50% in water, Aldrich) in ethyl alcohol (75 ml). The reaction medium is stirred for 3 hours at 23° C. (T bath). After evaporation of the solvent (T bath=24° C.; 35 mbar), petroleum ether (40/60) (150 ml) is added. The precipitate is filtered off and washed on the filter with petroleum ether (100 ml). The crude product is dissolved in a mixture of ethyl acetate (650 ml) and petroleum ether (650 ml) at ambient temperature and this solution is filtered through a layer of silica gel (Ø 9 cm, 2.0 cm of SiO₂).

The solvents are evaporated (T bath=22-24° C.) and the 2,4,6-trimethyl-3-(oxiran-2-ylmethoxy)benzaldehyde oxime is dried under atmospheric pressure at ambient temperature. A white solid (43.81 g; yield by mass of 88%) with a melting point of 77° C. is obtained. The molar purity is greater than 99% (¹H NMR).

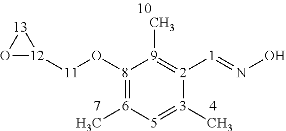

TABLE 5

| | δ ¹H (ppm) | δ ¹³C (ppm) |
|---|---|---|
| 1 | 8.2 | 147.3 |
| 2 | / | 129.1 |
| 3 | / | 129.2 |
| 4 | 2.18 | 20.1 |
| 5 | 6.85 | 130.2 |
| 6 | / | 130.3 |
| 7 | 2.15 | 15.7 |
| 8 | / | 153.1 |
| 9 | / | 131.7 |
| 10 | 2.18 | 13.1 |
| 11 | 3.48/3.96 | 73.3 |
| 12 | 3.27 | 49.6 |
| 13 | 2.60/2.76 | 42.8 |

Solvent DMSO

2.3.3 Synthesis of 2,4,6-trimethyl-3-(oxiran-2-ylmethoxy)benzonitrile oxide (compound C):

To a solution of 2,4,6-trimethyl-3-(oxiran-2-ylmethoxy)benzaldehyde oxime (17.00 g; 0.072 mol) in dichloromethane (350 ml) cooled to 3° C. is added, dropwise, an aqueous solution of NaOCI in water (62.9 g active Cl/I) (126 ml) over 10-15 minutes. The temperature of the reaction medium remains between 3° C. and 5° C. The reaction medium is subsequently stirred at a temperature of 3-5° C. for 1 hour. The aqueous phase is separated and extracted with dichloromethane (25 ml). The combined organic phases are washed with water (3 times 75 ml). The solvent is evaporated at reduced pressure (T bath=22° C., 35 mbar). Petroleum ether (40/60) (90 ml) is added to this residue and the suspension is maintained under stirring at ambient temperature for 10-12 hours. The precipitate is filtered off, washed on the filter with petroleum ether (3 times 30 ml) and lastly dried under atmospheric pressure at ambient temperature for 10-15 hours. A white solid (15.12 g, yield by mass of 90%) with a melting point of 63° C. is obtained. The molar purity is greater than 99% (¹H NMR).

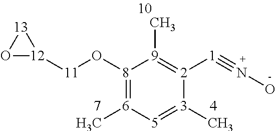

TABLE 6

| | δ 1H (ppm) | δ 13C (ppm) |
|---|---|---|
| 1 | 2.59/2.76 | 43.0 |
| 2 | 3.28 | 49.6 |
| 3 | 3.51/4.03 | 73.5 |
| 4 | / | 153.0 |
| 5 | / | 136.3 |
| 6 | 2.27 | 14.3 |
| 7 | / | 111.7 |
| 8 | / | / |
| 9 | / | 134.4 |
| 10 | 2.18 | 15.9 |
| 11 | 7.01 | 129.9 |
| 12 | / | 134.0 |
| 13 | 2.27 | 19.5 |

3. Production of the modified diene elastomers

3.1 Natural Rubber Modified with Compound A

0.98 phr of 3-methoxy-4-(oxiran-2-ylmethoxy)benzonitrile oxide (i.e. a molar fraction of 0.3 mol %), compound A obtained according to the process described in paragraph 2.1, with an NMR purity greater than 89 mol %, are incorporated into 100 g of natural rubber on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of less than 0.100 mol % with a molar grafting yield of less than 33%.

3.2 Natural Rubber Modified with Compound B

1.06 phr of 2-(glycidyloxy)-1-naphthonitrile oxide (i.e. a molar fraction of 0.3 mol %), with an NMR purity of 95 mol %, compound B obtained according to the process of paragraph 2.2, are incorporated into 100 g of natural rubber on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.162 mol % with a molar grafting yield of 54%.

3.3 Natural Rubber Modified with Compound C

1.03 phr of 2,4,6-trimethyl-3-(oxiran-2-ylmethoxy)benzonitrile oxide (i.e. a molar fraction of 0.3 mol %), with an NMR purity of 99 mol %, compound C obtained according to the process of paragraph 2.3, are incorporated into 100 g of natural rubber on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.070 mol % with a molar grafting yield of 23%.

3.4 Synthetic Polyisoprene Modified with Compound A

0.98 phr of 3-methoxy-4-(oxiran-2-ylmethoxy)benzonitrile oxide (i.e. a molar fraction of 0.3 mol %), compound A obtained according to the process described in paragraph 2.1, with an NMR purity greater than 89 mol %, are incorporated into 100 g of synthetic polyisoprene (containing 99.35% by weight of cis-1,4-isoprene units and 0.65% by weight of 3,4-isoprene units; Mn=375 000 g/mol and PDI=3.6, measured according to the method described above) on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.150 mol % with a molar grafting yield of 50%.

3.5 Synthetic Polyisoprene Modified with Compound B

1.06 phr of 2-(glycidyloxy)-1-naphthonitrile oxide (i.e. a molar fraction of 0.3 mol %), with an NMR purity of 95 mol %, compound B obtained according to the process of paragraph 2.2, are incorporated into 100 g of synthetic polyisoprene (containing 99.35% by weight of cis-1,4-isoprene units and 0.65% by weight of 3,4-isoprene units; Mn=375 000 g/mol and PDI=3.6, measured according to the method described above) on an open mill (external mixer at 30° C.).

The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.145 mol % with a molar grafting yield of 48%.

3.6 Synthetic Polyisoprene Modified with Compound C

1.03 phr of 2,4,6-trimethyl-3-(oxiran-2-ylmethoxy)benzonitrile oxide (i.e. a molar fraction of 0.3 mol %), with an NMR purity of 99 mol %, compound C obtained according to paragraph 2.3, are incorporated into 100 g of synthetic polyisoprene (containing 99.35% by weight of cis-1,4-isoprene units and 0.65% by weight of 3,4-isoprene units; Mn=375 000 g/mol and PDI=3.6, measured according to the method described above) on an open mill (external mixer at 30° C.). The mixture is homogenized fifteen times on this mill, then formed into slabs, before undergoing a heat treatment at 100° C. for 10 min under a press at a pressure of 10 bar. Analysis by ¹H NMR made it possible to determine a molar degree of grafting of 0.200 mol % with a molar grafting yield of 67%.

### 4. Ingredients Used in the Elastomeric Compositions

(1) Silica, Zeosil 1165MP, sold by Solvay;
(2)Bis [3-(triethoxysilyl)propyl] tetrasulfide (TESPT) silane, sold by Evonik under the reference Si69;
(3) Carbon black of N234 grade, sold by Cabot Corporation;
(4)N-(1,3-Dimethylbutyl)-N-phenyl-para-phenylenediamine, sold by Flexsys under the reference Santoflex 6-PPD;
(5) 2,2,4-Trimethyl-1,2-dihydroquinoline, sold by the company Flexsys;
(6) Zinc oxide (industrial grade), sold by the company Umicore;
(7) Stearin, Pristerene 4031, sold by the company Uniqema;
(8)N-Cyclohexyl-2-benzothiazolesulfenamide, sold by Flexsys under the reference Santocure CBS;
(9) Natural rubber modified with compound B, obtained according to the process described in paragraph 3.2;
(10) Natural rubber modified with compound C, obtained according to the process described in paragraph 3.3;
(11) Natural rubber modified with compound A, obtained according to the process described in paragraph 3.1;
(12) Synthetic polyisoprene modified with compound B, obtained according to the process described in paragraph 3.5;
(13) Synthetic polyisoprene modified with compound C, obtained according to the process described in paragraph 3.6;
(14) Synthetic polyisoprene modified with compound A, obtained according to the process described in paragraph 3.4.

### 5. Test 1

The aim of this test is to show the improvement in performance compromise of an elastomeric composition comprising natural rubber modified with compound A (composition C3, according to the invention) compared to a control elastomeric composition (composition T1) and to two comparative elastomeric compositions (compositions C1 and C2).

The contents of the various constituents of these compositions, expressed in phr, part by weight per hundred parts by weight of elastomer, are presented in Table 7.

TABLE 7

| | T1 | C1 | C2 | C3 |
|---|---|---|---|---|
| Unmodified natural rubber | 100 | (—) | (—) | (—) |
| Natural rubber modified | (—) | 100 | (—) | (—) |
| with compound B (9) | | | | |
| Natural rubber modified | (—) | (—) | 100 | (—) |
| with compound C (10) | | | | |
| Natural rubber modified | (—) | (—) | (—) | 100 |
| with compound A (11) | | | | |
| Reinforcing filler (1) | 55 | 55 | 55 | 55 |
| Coupling agent (2) | 5.5 | 5.5 | 5.5 | 5.5 |
| Carbon black (3) | 3 | 3 | 3 | 3 |
| Antioxidant (4) | 1.5 | 1.5 | 1.5 | 1.5 |
| TMQ (5) | 1 | 1 | 1 | 1 |
| Paraffin | 1 | 1 | 1 | 1 |
| ZnO (6) | 2.7 | 2.7 | 2.7 | 2.7 |
| Stearic acid (7) | 2.5 | 2.5 | 2.5 | 2.5 |
| CBS (8) | 1.63 | 1.63 | 1.63 | 1.63 |
| Sulfur | 1.33 | 1.33 | 1.33 | 1.33 |

The elastomeric compositions T1 and C1 to C3 are prepared in the following manner: the natural rubber modified with compound B or modified with compound C or modified with compound A or the unmodified natural rubber is introduced into an 85 cm³ Polylab internal mixer, filled to 70%, the initial vessel temperature of which is approximately 100° C.

Next, for each of the elastomeric compositions, the reinforcing filler(s), the agent for coupling the filler with the diene elastomer and then, after kneading for one to two minutes, the various other ingredients, with the exception of the vulcanization system, are introduced. Thermomechanical working (non-productive phase) is then carried out in a step which lasts in total approximately from 5 to 6 minutes, until a maximum dropping temperature of 160° C. is reached.

The mixture thus obtained is recovered and cooled and the vulcanization system (sulfur and the sulfenamide-type accelerator) is then added on an external mixer (homofinisher) at 25° C., the whole being mixed (productive phase) for approximately 5 to 6 minutes.

The elastomeric compositions thus obtained are subsequently calendered in the form of slabs (thickness of 2 to 3 mm) for measurement of their physical or mechanical properties.

The rubber properties of these compositions are measured after curing at 150° C. for 30 minutes. The results obtained are given in Table 8.

TABLE 8

| Compositions | T1 | C1 | C2 | C3 |
|---|---|---|---|---|
| MA300/MA100 at 23° C. (base 100) | 100 | 125 | 99 | 133 |
| MA300/MA100 at 100° C. (base 100) | 100 | 125 | 107 | 129 |
| Tan (δ)_{max at 60° C.} (base 100) | 100 | 74 | 93 | 65 |
| G*_{50% return at 60° C.} (base 100) | 100 | 101 | 99 | 104 |

The elastomeric composition of the invention C3 simultaneously exhibits, compared to the control T1 and comparative C1 and C2 elastomeric compositions, a significant improvement in the reinforcement index (MA300/M100) and an improvement in the rolling resistance/stiffness performance compromise (reduction in tan(δ)_{max at 60° C.}. and increase in G*_{50% return at 60° C.}).

### 5. Test 2

The aim of this test is to show the improvement in performance compromise of an elastomeric composition comprising a synthetic polyisoprene modified with compound A (composition C6 according to the invention) compared to a control elastomeric composition (composition T2) and to two comparative elastomeric compositions (compositions C4 and C5).

The contents of the various constituents of these elastomeric compositions, expressed in phr, part by weight per hundred parts by weight of elastomer, are presented in Table 9.

TABLE 9

| | T2 | C4 | C5 | C6 |
|---|---|---|---|---|
| Unmodified synthetic polyisoprene | 100 | (—) | (—) | (—) |
| Synthetic polyisoprene modified | (—) | 100 | (—) | (—) |
| with compound B (12) | | | | |
| Synthetic polyisoprene modified | (—) | (—) | 100 | (—) |
| with compound C (13) | | | | |
| Synthetic polyisoprene modified | (—) | (—) | (—) | 100 |
| with compound A (14) | | | | |
| Reinforcing filler (1) | 55 | 55 | 55 | 55 |
| Coupling agent (2) | 5.5 | 5.5 | 5.5 | 5.5 |
| Carbon black (3) | 3 | 3 | 3 | 3 |
| Antioxidant (4) | 1.5 | 1.5 | 1.5 | 1.5 |
| TMQ (5) | 1 | 1 | 1 | 1 |
| Paraffin | 1 | 1 | 1 | 1 |
| ZnO (6) | 2.7 | 2.7 | 2.7 | 2.7 |
| Stearic acid (7) | 2.5 | 2.5 | 2.5 | 2.5 |
| CBS (8) | 1.63 | 1.63 | 1.63 | 1.63 |
| Sulfur | 1.33 | 1.33 | 1.33 | 1.33 |

The elastomeric compositions T2 and C4 to C6 are prepared according to the process described above for the elastomeric compositions T1 and C1 to C3.

The rubber properties of these elastomeric compositions are measured after curing at 150° C. for 30 minutes. The results obtained are given in Table 10.

TABLE 10

| Compositions | T2 | C4 | C5 | C6 |
|---|---|---|---|---|
| MA300/MA100 at 23° C. (base 100) | 100 | 124 | 124 | 154 |
| MA300/MA100 at 100° C. (base 100) | 100 | 116 | 112 | 152 |
| Tan (δ)_{max at 60° C.} (base 100) | 100 | 60 | 90 | 60 |
| G*_{50% return at 60° C.} (base 100) | 100 | 87 | 87 | 93 |

The elastomeric composition of the invention C6 simultaneously exhibits, compared to the control T2 and comparative C4 and C5 elastomeric compositions, a significant improvement in the reinforcement index (MA300/M100) and an improvement in the rolling resistance/stiffness performance compromise (reduction in tan(δ)_{max at 60° C.}. and increase in G*_{50% return at 60° C.}).

1.-15. (canceled)

16. An elastomeric composition based on at least one diene elastomer, at least one reinforcing filler, at least one crosslinking agent and at least one compound, optionally grafted onto the at least one diene elastomer, of formula (I) 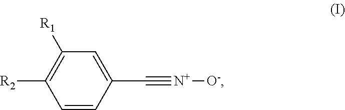
in which:
R₁ represents a chemical group selected from the group consisting of —OCH₃, —OCH₂CH₃ and —OR₃;
R₂ represents a chemical group selected from the group consisting of —OCH₃ and —OR₃, provided that R₁ or R₂ is —OR₃; and
R₃ represents a chemical group of formula (II) 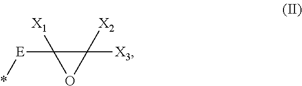
in which:
E represents a divalent C₁-C₁₂ hydrocarbon group optionally comprising one or more heteroatoms;
X₁, X₂, and X₃, which may be identical or different, represent a hydrogen atom, a C₁-C₆ alkyl or a C₆-C₁₄ aryl; and
represents an attachment of the group of formula (II) to the oxygen atom.

17. The elastomeric composition according to claim 16, wherein a content of the compound of formula (I) is within a range extending from 0.05 mol % to 15 mol %.

18. The elastomeric composition according to claim 16, wherein R₁ represents a chemical group selected from the group consisting of —OCH₃ and —OCH₂CH₃, and R₂ is —OR₃.

19. The elastomeric composition according to claim 16, wherein E represents a C₁-C₁₂ alkanediyl.

20. The elastomeric composition according to claim 16, wherein E is selected from the group consisting of methanediyl, ethanediyl and propanediyl.

21. The elastomeric composition according to claim 16, wherein X₁, X₂, and X₃, which may be identical or different, are selected from the group consisting of a hydrogen atom, C₁-C₆ alkyl and phenyl.

22. The elastomeric composition according to claim 16, wherein X₁, X₂, and X₃, which are identical, are each a hydrogen atom.

23. The elastomeric composition according to claim 16, wherein the compound of formula (I) is a compound of formula (Ia1)

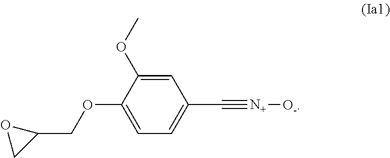

24. The elastomeric composition according to claim 16, wherein the at least one diene elastomer is selected from the group consisting of ethylene/propylene/diene monomer copolymers, butyl rubbers, natural rubber, synthetic polyisoprenes, polybutadienes, butadiene copolymers, isoprene copolymers, and mixtures thereof.

25. The elastomeric composition according to claim 16, wherein the at least one diene elastomer is selected from the group consisting of natural rubber, synthetic polyisoprenes, polybutadienes, butadiene copolymers, isoprene copolymers and mixtures thereof.

26. The elastomeric composition according to claim 16, wherein the at least one reinforcing filler is selected from carbon black, an inorganic reinforcing filler and mixtures thereof.

27. The elastomeric composition according to claim 16, wherein the at least one crosslinking agent is part of a vulcanization crosslinking system.

28. A semi-finished article for a tire comprising at least one elastomeric composition according to claim 16.

29. The semi-finished article for a tire according to claim 28, wherein the semi-finished article is a tire tread.

30. A tire comprising at least one elastomeric composition according to claim 16.

31. A tire comprising at least one semi-finished article for a tire according to claim 28.
